(19) United States
(12) Patent Application Publication
(10) Pub. No.: US 2023/0418837 A1
(43) Pub. Date: Dec. 28, 2023

(54) System for Providing Data

(71) Applicant: Siemens Aktiengesellschaft, München (DE)

(72) Inventors: Rebecca Johnson, München (DE); Steffen Lamparter, Feldkirchen (DE); Anja Simon, Feldkirchen (DE)

(73) Assignee: Siemens Aktiengesellschaft, München (DE)

(21) Appl. No.: 18/247,175

(22) PCT Filed: Sep. 16, 2021
(86) PCT No.: PCT/EP2021/075525

§ 371 Date: Mar. 29, 2023

(30) Foreign Application Priority Data
Sep. 30, 2020 (DE) 10 2020 212 317.9

(51) Int. Cl. G06F 16/27; G06F 16/36

(52) U.S. Cl. CPC G06F 16/27; G06F 16/367

(57) ABSTRACT

Various embodiments of the teachings herein include a system for automatically synchronizing and providing data for retrieval by intelligent machines and/or users. For example, the system may include: a computing unit providing a platform; an input and output unit; and an artificial intelligence passively monitoring the input and output unit and learning from the responses, adaptations and/or assessments of the user. The artificial intelligence automatically carries out synchronization, in line with the input, of the various data types, metadata and/or memory levels of the inputs and/or outputs, develops search strategies and/or makes search results available in the output unit.

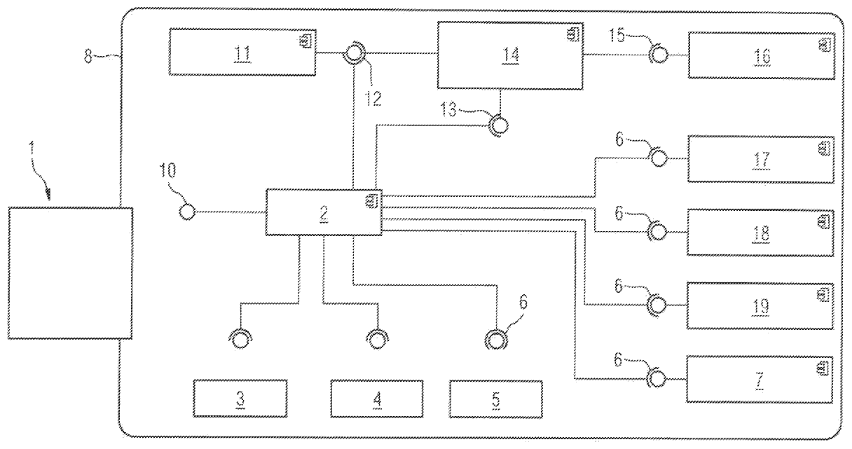

### CROSS-REFERENCE TO RELATED APPLICATIONS

This application is a U.S. National Stage Application of International Application No. PCT/EP2021/075525 filed Sep. 16, 2021, which designates the United States of America, and claims priority to DE Application No. 10 2020 212 317.9 filed Sep. 30, 2020, the contents of which are hereby incorporated by reference in their entirety.

### TECHNICAL FIELD

The present disclosure relates to data management. Various embodiments include system and/or methods for providing data, in particular data generated in industry, for retrieval.

### BACKGROUND

There are a number of data catalogs by means of which the knowledge of a company, a community, etc. is stored for retrieval. For example, object-related and/or project-related data about research and development work relating to the individual products are collected, stored, sorted and provided. Commercial data, trading data, business data, corporate data, knowledge graphs—for example Google Knowledge Graph —, location, weather, etc. are then able to be retrieved at any time. Lastly, there are reference data which are able to be retrieved using benchmarking, that is to say comparative analysis of results and/or processes using a set reference value and/or reference process, which are gathered and stored.

All of these data are available within a company, in principle, but at present it is still difficult to obtain all data, depending on the user. This is the case in particular because the respective data access is on different levels.

### SUMMARY

The teachings of the present disclosure include systems and/or methods for providing and synchronizing the available data. For example, some embodiments include a system for automatically synchronizing and providing data for retrieval by intelligent machines and/or users, comprising a computing unit which provides a platform, and at least one input and output unit, wherein there is provision in the system for an artificial intelligence which at least in some cases passively monitors the input and output unit and/or learns from the responses, adaptations and/or assessments of the user, automatically carries out synchronization, in line with the input, of the various data types, metadata and/or memory levels of the inputs and/or outputs, develops search strategies and/or makes search results available in the output unit.

In some embodiments, the system has interfaces to internal data pools.

In some embodiments, the system has applications for simultaneous synchronization.

In some embodiments, the system has an artificial intelligence which can produce taxonomies in an automated manner.

In some embodiments, the system has an artificial intelligence which can produce an ontology in an automated manner.

In some embodiments, the system has an artificial intelligence which can configure a search strategy.

In some embodiments, the system has subsystems which are each linked to the application via interfaces.

In some embodiments, the system has at least one API interface.

In some embodiments, the system comprises a metadata model based on DCATv2.

### BRIEF DESCRIPTION OF THE DRAWINGS

The teachings of the present disclosure are explained in more detail hereinbelow on the basis of an example which shows one embodiment:

The FIGURE shows an input and output device with a corresponding user interface, and an underlying application architecture all incorporating teachings of the present disclosure.

### DETAILED DESCRIPTION

The subject matter of the present disclosure include systems and/or methods for automatically synchronizing and providing data for retrieval by intelligent machines and/or users. As an example, some embodiments include a system comprising a computing unit which provides a platform, and at least one input and output unit, wherein there is provision in the system for an artificial intelligence which at least in some cases passively monitors the input and output unit and/or learns from the responses, assessments and/or adaptations of the user, automatically carries out synchronization, in line with the input, of the various data types, metadata and/or memory levels of the inputs and/or outputs, develops search strategies and/or makes search results available in the output unit.

The data are provided on a user-driven basis by way of upload and automated synchronization of both the readability of the data by way of the system and the availability of the data by way of the intelligent machine and/or a user. These do not constitute data lake management, as is already known, but rather the focus is on the “community”, that is to say, like Facebook and Instagram, the data are assessed. The data quality is thus regulated by the community, and data mass is structured by way of ontology as a structure AND search option for users, user activity is enhanced by gamification elements and helpers, such as, e.g., 3D data compression, image conversion into icons, or black-and-white, etc.

A “platform” in the present text denotes a uniform base on which applications or application programs are executed and/or developed. The platform abstracts complicated details for an application. On the one hand, these details may be unknown properties of the applications; on the other hand, they may comprise competing manufacturer APIs which are reduced.

The “computing unit” comprises at least one processor and at least one memory and can be found as a “memory pool” in the center of a system. The computing unit can have connections both to internal—by which is meant network-internal—or external data sources—that is to say, e.g., the Internet.

“System” in the present text refers to a network which comprises a number of modules, which are optionally connected to one another but always to the computing unit, wherein the network has connections to “internal” and/or “external” data sources.

“Modules” refers to all kinds of input devices, such as a computer by means of which video data, audio data or other data can be uploaded into the system and/or queried.

“Module” also refers to an output device by means of which results are output, however. An input unit and/or an output unit can comprise a computer.

Unless the description that follows states otherwise, the terms “carry out”, “compute”, “ascertain”, “generate”, “configure”, “reconstruct” and the like preferably relate to actions and/or processes and/or processing steps which alter and/or generate data and/or convert the data into other data, wherein the data are represented or can be present in particular as physical variables, for example as electrical pulses.

The expression “computer” should in particular be interpreted as broadly as possible in order to cover in particular all electronic devices having data processing properties. Computers can therefore be for example personal computers, servers, hand-held computer systems, pocket PC devices, mobile radio devices and other communication devices which can process data in a computer-aided manner, processors and other electronic devices for data processing.

In the context of the disclosure, “in a computer-aided manner” can be understood to mean, for example, an implementation of the method in which in particular a processor performs at least one method step of the method.

The artificial intelligence—AI—learns by passively monitoring the output and input unit, wherein it is trained automatically, in particular by way of the responses of the user. On the other hand, the AI can also be trained in an automated manner by way of an internal and/or external data source.

In either case, the AI is there so as, when data are uploaded via the input device, to automatically capture the metadata of the data, to analyse these metadata and to synchronize the data in accordance with the processing by the computing unit of the system.

In some embodiments, the AI is also capable of then assigning these data to one, a plurality of or many subject areas and/or themes.

The AI merges already existing databases, establishes interrelationships between existing databases and finally establishes an order within the associated data. The AI is therefore able to configure a search strategy for a particular search query.

Moreover, the AI is able to establish both taxonomy and ontology for a predefined subject area predefined by the search inquiry. The system transmits this ontology to the user as the result of a search query using the output unit—which comprises an imaging unit for this purpose.

“Ontologies” are part of the knowledge representation in the field of artificial intelligence. In contrast to a “taxonomy”, which forms only a hierarchical subdivision, an ontology constitutes a “network” of information with logical relations.

“Subject area” in the present text refers, for example, to all available information on a subject, person, project, product, unit, etc.

For example, for a search request regarding the subject employee XY, the system can present their education, their specialist activity, their membership in Teams, their customer contacts, their location, the current weather at their location, etc. to the user as a search result as part of an ontology.

On the other hand, for a search request concerning the status of a project relating to a predefined theme, the system can present all available presentations, work reports, all employees involved, their fields of activity, locations, suppliers, etc. as a search result in the form of an ontology.

For example, in the case of a gas turbine manufacturer, an employee inputs “gas turbine” and, instead of a conventional list of results, a spider's web with “gas turbine” in the middle is revealed to the employee. The web holds context and related data, such as owners of the gas turbine, site of the gas turbine, age, power, etc. and/or other “objectively indisputable” data relating to the gas turbine. Comments, assessments and/or other inputs with respect to the gas turbine can also be seen in the web, however.

If a point in the web, e.g. “site of the gas turbine”, is then clicked on, for example, the result seen is inter alia whether there are gas turbines at the same site, and if so how many and where. If a further gas turbine is then clicked on, for example, it can be seen straight away who the owner is. E.g. simple selection and/or clicking then allows the department to be seen as well as employees and/or the manager, who can then be clicked on and thus contacted, e.g. in order to invite them to the employee's own department. Here, the teachings of the present disclosure include a completely different kind of search result and/or navigation.

In order to generate the volumes of data, the input unit provides all users with the opportunity to upload any desired data into the system, wherein the AI passively monitors the system, for example, and, at the same time as the upload, initiates the synchronization of the data and/or affords different opportunities for linking the data. In addition, the user has the option to track the use of the data that he uploaded, for example by means of clicks, numbers of hits, likes, etc. In other words, the user uploads his data, and the community can confirm the data quality by way of ratings. In this case, in addition or alternatively, provision can be made for the user to be assigned playful roles such as “data queen”.

As a result of the assessment by other users and/or AI, the system and for example also the other users know which data can be used directly for training their neural networks—e.g. gas turbines detector—or whether the data should or would have to be reworked, or whether the quality of the data is quite simply poor. For example, data repositories can be cloned, post-processed, improved and/or even published again.

In some embodiments, APIs are used as interfaces to other applications. “API” stands for “Application Programming Interface”, by means of which the system facilitates linking to a software system of another program.

In some embodiments, the application DCATv.2—Data Catalog Vocabulary version 2—provides an opportunity for special links in the system. By means of DCATv2, links to various data catalogs on the Internet are possible for the first time. In particular, DCATv2 is an RDF vocabulary which facilitates interaction between the data catalogs such that the content of the data of different data catalogs can be accessed on the Internet in an automated manner.

DCAT may be advantageous because this ontology can be extended using individual “branches” such that, within a company-internal intranet, individual categories specific to the company can be mapped. For example, particular business units and/or cost centers and/or customer hierarchies, etc. can be mapped. Thus, not only data but rather entire ontologies can be uploaded in the system. In this case, there are of course approval processes for the ontologies, that is to say the uploaded ontology extensions are firstly reviewed by appropriate knowledge engineers and then approved. However, structuring and findability of data can then be raised in the context of the respective companies, for example. As such, new data formats can also be introduced and described. For example, if the ontology knew or had no weather data, which are quite clearly different from financial data, a user can additionally upload a weather data ontology into the system and from that point on all users can comfortably upload weather data.

A data catalog is a catalog of metadata which contains the definitions and representation rules for all application data of a business and the relationships between the different data objects so that the database is structured in a redundancy-free and uniform manner. It is an instance of application of a specific data model.

The system makes it possible to combine a keyword search with a knowledge graph.

The FIGURE shows an input and/or output unit 1, which for example shows the illustrated “Store. Share. Find. Explore” as a screen display. This can then be found on the input and/or output unit as a user interface. The input and/or output unit makes the application 1 “Datafinity” available and the latter in turn makes a number of subsystems 8 of the system available via corresponding interfaces.

The user interface is controlled by the application 2 “Datafinity”, in particular “Datafinity Content Manager”. The application “Datafinity” has a wide variety of programs available in the system, for example “Compress CAD Model” 3, “Visualize 3D Model” 4, etc., which are each connected via APIs 6, that is to say intelligent interfaces.

These are so-called “helpers”, actually quite sophisticated and/or expensive instruments which are made available to a user in order to motivate him to upload his data. If, by way of example, a data repository of images is uploaded, image processing functions—again by way of example—are offered in return. If a user uploads, e.g., 3D models, he is offered, e.g., compression tools and/or one or more interfaces to a virtual reality rendering. If laser scans are uploaded, e.g. a virtual inspection can be generated. These tools can in turn be used to increase the data quality.

Thus, the tools can be used, for example, to process a number of images which are obtained as the result of a corresponding search, e.g. for a gas turbine. These images all have different sizes, different colors, have different people on them, etc. Using the helpers, the user can there and then conveniently customize the images, trigger them to a uniform size and generate a uniform color scheme. The user then uploads this revision again and makes it available to the community and/or uses it himself for training.

There is likewise a smart interface to a search engine 7, for example the “DCM search engine 7”.

The present disclosure provides, for the first time, an opportunity for automatic provision of data for retrieval by intelligent machines, wherein metadata are extracted during uploads, in particular also in a certain structure, wherein an AI is used which finds examples of similar subjects, issues, problem cases, representations, calculations, spectra and distribution diagrams during the upload already and makes them available to the user, wherein the AI is able to be trained by way of the responses of the users and thus learns which examples are apt and which are at least not immediately recognized.

The data can, however, also be uploaded automatically, for example, such that for example a robot is made aware of other examples by means of the automated upload of its data by the AI, wherein the robot then learns from another robot with similar instances of application for its parameterization and/or programming.

During the upload, the AI of the system is used to perform a synchronization which allows all permissible users to access the data.

The system uses the AI to provide, for the first time, an opportunity to establish not only a taxonomy but also an ontology for all available data relating to a search query in an automated manner. This is done for the community for example by introducing gamification elements, such as, for example, an avatar, an obstacle, a competition, awards, honors and different levels, and/or using converters and/or helpers.

### LIST OF REFERENCE SIGNS

1 input/output device
2 controller and platform
3 module for CAD model
4 module for visualizing a 3D model
identifying a graphical representation
6 intelligent API interface
7 search engine
8 module with many diverse subsystems
10 interface from the output/input device to the platform
11 module for comparing the input with the stored authentication of the user
12 interface from the platform to the authentication module
13 interface to the RDF-based knowledge graph
14 knowledge graph data pool
15 interface to the RDF graph data pool
16 graph data pool
17 memory for DCM (Data Cache Manager) content
18 memory for DCM files
19 memory for DCM content cacher

What is claimed is:

1. A system for automatically synchronizing and providing data for retrieval by intelligent machines and/or users, the system comprising:
a computing unit providing a platform;
an input and output unit; and
an artificial intelligence passively monitoring the input and output unit and learning from the responses, adaptations and/or assessments of the user;
wherein the artificial intelligence automatically carries out synchronization, in line with the input, of the various data types, metadata and/or memory levels of the inputs and/or outputs, develops search strategies and/or makes search results available in the output unit.

2. The system as claimed in claim 1, further comprising interfaces to internal data pools.

3. The system as claimed in claim 1, further comprising applications for simultaneous synchronization.

4. The system as claimed in claim 1, wherein the artificial intelligence can produce taxonomies in an automated manner.

5. The system as claimed in claim 1, wherein the artificial intelligence can produce an ontology in an automated manner.

6. The system as claimed in claim 1, wherein the artificial intelligence can configure a search strategy.

7. The system as claimed in claim 1, further comprising subsystems each linked to the application via interfaces.

8. The system as claimed in claim 1, further comprising an API interface.

9. The system as claimed in claim 1, further comprising a metadata model based on DCATv2.
